(19) United States
(12) Patent Application Publication
(10) Pub. No.: US 2013/0182652 A1
(43) Pub. Date: Jul. 18, 2013

(54) METHODS AND APPARATUS IN A WIRELESS NETWORK

(71) Applicants: Fei TONG, Meldreth (GB); Andrei Popescu, Cambridge (GB); Alexander Thoukydides, Cambridge (GB)

(72) Inventors: Fei TONG, Meldreth (GB); Andrei Popescu, Cambridge (GB); Alexander Thoukydides, Cambridge (GB)

(21) Appl. No.: 13/350,616

(22) Filed: Jan. 13, 2012

(51) Int. Cl. H04W 72/04; H04W 88/08; H04W 84/02

(52) U.S. Cl. 370/329

(57) ABSTRACT

Methods and apparatus are described for a wireless local area network. In order to improve network throughput for networks with a high number of stations and with wide network coverage, stations are divided into groups, with wireless resources for communications between access points and stations divided and allocated on a group-by-group basis. The stations are then able to compete for usage of the resources allocated to their respective group(s).

### TECHNICAL FIELD

The present invention relates to wireless communications, and particularly to methods, access points, stations, and controllers for access points and stations, all for use in wireless local area networks.

### BACKGROUND

The IEEE 802.11ah amendment defines an orthogonal frequency division multiplexing (OFDM) physical layer (PHY) operating in the license-exempt bands below 1 GHz and enhancements to the IEEE 802.11 medium access control layer (MAC) to support this PHY. The IEEE 802.11af amendment similarly defines an OFDM PHY for operation in the TV white spaces. Some distinguishing features of these amendments are the support of outdoor coverage up to 1 km and large numbers (>2007, the previous limit for 802.11 specifications) of stations with low data rate (100 kbit/s as the lowest). Their aim is to support a variety of distinctive applications, such as sensor networks and cellular network off-loading, resulting in a wide range of traffic characteristics in terms of data rate, payload size and duty cycle.

There are two major problems in using the existing IEEE 802.11 MAC for those types of applications. First, the IEEE 802.11 MAC is a carrier sense multiple access with collision avoidance (CSMA/CA) based medium access scheme; when the number of stations competing for the medium is very large, the number of collisions occurring for each successful transmission will be high. Although the aggregate traffic load is low (in terms of data rate), the network throughput may be compromised and unable to support the traffic load specified in the amendment.

Second, successful CSMA/CA operation requires that the stations can hear each other to achieve collision avoidance. Deploying a network with wide outdoor coverage (1 km radius) and limited transmission power due to regulatory constraints (14 dBm max ERP in Europe, 1 mW in Japan, 3 mW in Korea and 10 mW in China for sub 1 GHz operation) means that the number of station pairs that cannot hear each other is much higher than for a conventional WLAN indoor deployment (with tens of metres of coverage). Stations that are unable to hear each other will compromise the CSMA/CA operation due to their simultaneous transmissions, resulting in low network throughput.

Moreover, the degradation in network performance caused by these collisions is worse than just the time taken to retransmit the original packets. First, in an attempt to reduce the risk of further collisions, the IEEE 802.11 MAC doubles the size of the contention window (up to a maximum size) for subsequent retries, thereby increasing the inter-frame gap between packets. Secondly, the transmitting station will typically assume that the error was caused by poor channel conditions so will fall back to more robust modulation rates, thereby resulting in increased packet durations for the same payload.

### SUMMARY OF INVENTION

According to embodiments of the present invention, each station is allocated into one or more groups of stations. Wireless resources for communication between the stations and one or more access points (e.g. time, frequency and/or codes) are partitioned into portions and each group allocated a particular portion of those resources. The stations of a particular group are then permitted to compete for access using the portion of resources allocated to that group. Stations which are not allocated to that group are not permitted to compete for those resources.

According to a first aspect of the present invention, there is provided a method in a station of a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point. The method comprises: identifying a group of stations to which the station is allocated; and transmitting one or more communications to the access point or listening for communications intended for the station from the access point, using the portion of wireless resources reserved for said identified group of stations.

In a second aspect of the present invention, there is provided a station for a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point. The station comprises: a transceiver for transmitting communications to the access point and receiving communications from the access point; and a controller for controlling the transceiver, the controller configured to: identify a group of stations to which the station is allocated; and control the transceiver to transmit one or more communications to the access point or to listen for communications intended for the station from the access point, using the portion of wireless resources reserved for said identified group of stations.

In a further aspect, the present invention provides a controller for a station of a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point, the station further comprising a transceiver for transmitting communications to the access point and receiving communications from the access point. The controller is configured to: identify a group of stations to which the station is allocated; and control the transceiver to transmit one or more communications to the access point or to listen for communications intended for the station from the access point, using the portion of wireless resources reserved for said identified group of stations.

In a yet further aspect of the present invention, there is provided a method in an access point of a wireless local area network, the network comprising a plurality of stations which can communicate with the access point using wireless resources, wherein each station is allocated to one or more of a plurality of groups of stations. The method comprises: transmitting a beacon signal to the plurality of stations, the beacon signal identifying a portion of the wireless resources and the group of stations for which the identified portion of wireless resources is reserved for communications with the access point.

Similarly, the present invention provides an access point for a wireless local area network, the network comprising a plurality of stations which can communicate with the access point using wireless resources, wherein each station is allocated to one or more of a plurality of groups of stations. The access point comprises: a transceiver for transmitting communications to the plurality of stations and receiving communications from the plurality of stations; and a controller for controlling the transceiver, the controller configured to: control the transceiver to transmit a beacon signal to the plurality of stations, the beacon signal identifying a portion of the wireless resources and the group of stations for which the identified portion of wireless resources is reserved for communications with the access point.

A controller is provided for an access point for a wireless local area network, the network comprising a plurality of stations which can communicate with the access point using wireless resources, wherein each station is allocated to one or more of a plurality of groups of stations, the access point further comprising a transceiver for transmitting communications to the plurality of stations and receiving communications from the plurality of stations. The controller is configured to: control the transceiver to transmit a beacon signal to the plurality of stations, the beacon signal identifying a portion of the wireless resources and the group of stations for which the identified portion of wireless resources is reserved for communications with the access point.

### BRIEF DESCRIPTION OF THE DRAWINGS

For a better understanding of the present invention, and to show more clearly how it may be carried into effect, reference will now be made, by way of example, to the following drawings, in which:

FIG. 1 shows a wireless network according to embodiments of the present invention;

FIG. 2 shows an access point according to embodiments of the present invention;

FIG. 3 shows a station according to embodiments of the present invention;

FIG. 4 shows a signalling scheme according to an embodiment of the present invention;

FIG. 5 shows a signalling scheme according to a further embodiment of the present invention; and

FIG. 6 is a flow chart illustrating a method in an access point according to embodiments of the present invention.

### DETAILED DESCRIPTION

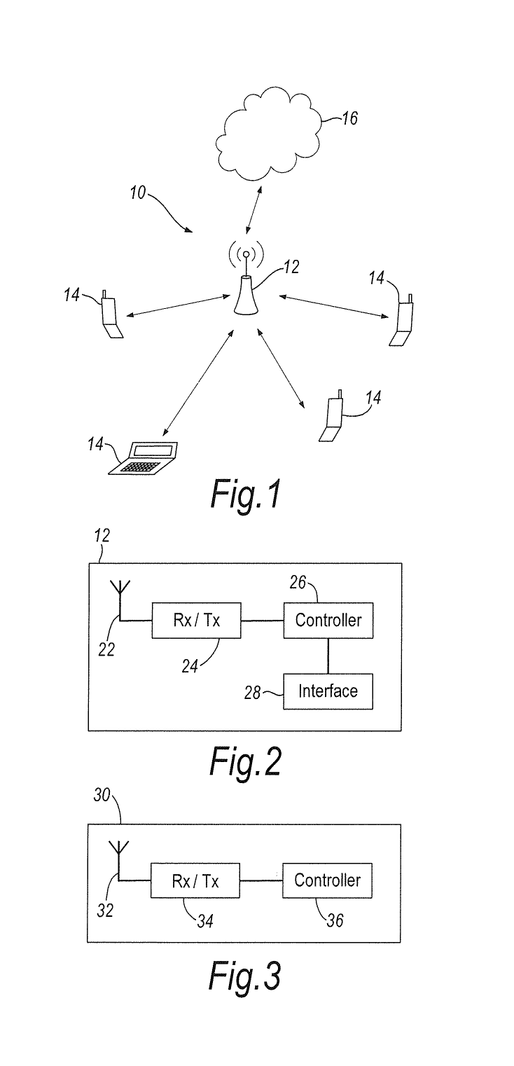

FIG. 1 shows a wireless local area network 10 according to embodiments of the present invention. As will be clear from the discussion above, the network 10 is designed to cover a reasonably wide area, up to one or several kilometres in radius. The term “local area” is thus intended to indicate that the network falls generally within the 802.11 specifications, providing wireless access to the internet and other wired networks.

The network 10 comprises an access point 12, and a plurality of stations 14 which communicate with the access point 12. Those skilled in the art will appreciate that the network will typically comprise more than one access point, but the drawing is sufficient to explain embodiments of the present invention and thus further detail is omitted for the purposes of clarity. The term “station” is intended to cover any and all devices which communicate wirelessly with the access point 12 to access the internet and/or other wired networks. Thus the plurality of stations 14 may comprise mobile phones, laptops, computers, PDAs, etc. Those skilled in the art may have used the term “station” previously to cover both such devices and access points; in this specification the term “station” is exclusive of access points, which are referred to separately.

The network further comprises a wired packet-switched network 16 such as, for example, the internet. The access point 12 communicates with the packed-switched network 16 and thereby allows the stations 14 to access the network 16.

FIG. 2 is a schematic illustration of an access point 12 according to embodiments of the present invention. Again, only those components which aid the description of the invention are included for clarity.

Thus, the access point comprises an antenna 22, with which wireless communications can be received and transmitted, and Rx/Tx circuitry 24 connected to the antenna 22 in order to decode the received signals and to encode signals to be transmitted. A controller 26 is coupled to the Rx/Tx circuitry 24, and is operational to control the access point 12 generally. Finally, an interface 28 is provided so that the access point 12 can connect to the packed-switched network 16. In operation, therefore, packet-switched signals are received via the interface 28, and can be passed by the controller 26 to the Rx/Tx circuitry 24 for transmission to one or more stations 14.

Likewise, wireless signals can be received via the antenna 22, and passed by the controller 26 to the interface 28 for transmission via the packet-switched network 16. These and further operations of the access point 16 will be described in greater detail below.

FIG. 3 is a schematic illustration of a station 14 according to embodiments of the present invention. Again, only those components which aid the description of the invention are included for clarity.

The station comprises an antenna 32, with which wireless communications can be received and transmitted, and Rx/Tx circuitry 34 connected to the antenna 32 in order to decode the received signals and to encode signals to be transmitted. A controller 36 is coupled to the Rx/Tx circuitry 34, and is operational to control the station 14 generally. In operation, wireless signals are received via the antenna 32 (i.e. from the access point 12), decoded by the Rx/Tx circuitry 34, and processed by the controller 36. Likewise, signals top be transmitted can be generated with the controller 36, encoded by the Rx/Tx circuitry 34, and passed to the antenna 32 for transmission (i.e. to the access point 12). These and further operations of the station 14 will be described in greater detail below.

As described above, a problem with recent amendments to the 802.11 specifications is that increased numbers of stations are expected to connect to the same access point and over increased distances. These factors are expected to increase the number of collisions between stations competing for access and therefore to reduce the throughput of any given network.

According to embodiments of the present invention, each station is allocated into one or more groups of stations. Wireless resources for communication between the stations and one or more access points (e.g. time, frequency and/or codes) are partitioned into portions and each group allocated a particular portion of those resources. The stations of a particular group are then permitted to compete for access using the portion of resources allocated to that group. Stations which are not allocated to that group are not permitted to compete for those resources.

The present invention is applicable to any wireless resources with which a station may communicate with an access point. In the examples given hereinafter, time is partitioned between the various groups, such that each group of stations is permitted to compete for access during a defined access interval. However, in other embodiments different frequencies or ranges of frequencies may be allocated to the groups of stations, with stations of those groups allowed to compete for access using the frequencies allocated to their group(s). In still further embodiments, one or more different codes may be allocated to each group of stations, such that transmissions between the access point and those groups of stations are encoded with the allocated code(s) and stations of each group can compete for access using the allocated code(s).

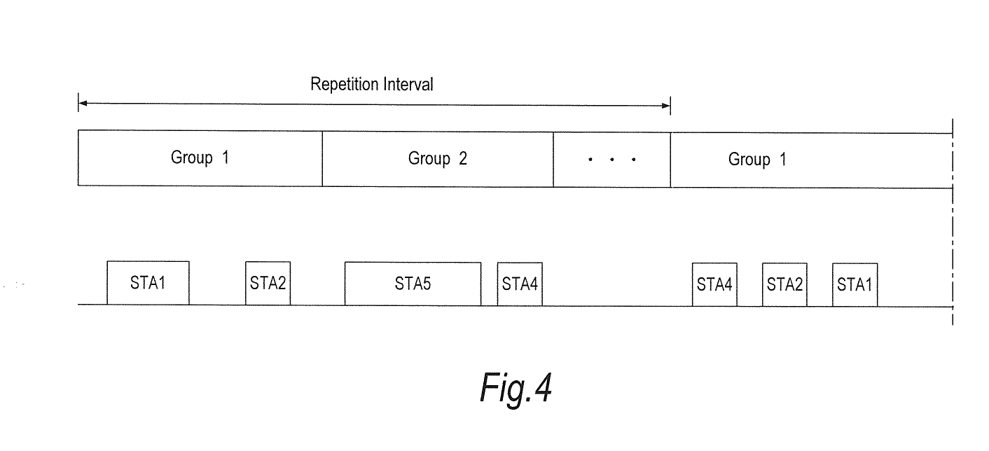

FIG. 4 shows a signalling diagram between an access point and several stations according to one embodiment. Time is represented on the horizontal axis, and is partitioned into a plurality of access intervals of which only a first access interval and a second access interval are illustrated for clarity. After a period of time (the “repetition interval”) another access interval is allocated to Group 1. The repetition interval for each group may be the same or different. In the latter case, therefore, some intervals will repeat more frequently than others.

In this example, five stations are shown according to references STA1, STA2, STA3, STA4 and STA5. Stations STA1, STA2 and STA4 are allocated to a first group of stations (“Group 1”), and stations STA3, STA4 AND STA5 are allocated to a second group of stations (“Group 2”). Thus it will be apparent that generally each station can be allocated to more than one group of stations. In this example, STA4 is allocated to both Groups 1 and 2.

During the first access interval, allocated to Group 1, STA1 and STA2 each transmit communications to the access point. The stations STA1 and STA2 must compete with each other to transmit their respective communications. Once the first access interval has elapsed, the second access interval begins, and STA5 and STA 4 transmit communications to the access point. Again, STA5 and STA4 compete with each other to use the access interval and ensure that their respective signals do not collide with each other.

Once the repetition interval has elapsed, a third access interval is allocated to Group 1. In this interval, STA4, STA2 and STA1 each transmit signals to the access point as illustrated.

One example of how stations might compete is by first listening for transmissions from or to other stations using the allocated resources, and then sending a transmission only if there are no existing signals which might interfere with the station's own transmission. Similarly, the access point may only transmit communications to one or more of the stations of a particular group of stations once it has determined that no other stations are using those allocated resources.

When first connecting to the network a station will not generally be associated with a particular access point, or be allocated to a particular group of stations. This represents a problem as the resources for each access point are allocated to groups of stations. In order to initiate association with an access point, therefore, the station must first discover the access point and its access interval timings (or other allocation of wireless resources) without transmitting on the channel. It must also determine an initial (or default) group of stations to which it belongs.

Conventionally, and in one embodiment, a station will perform active scanning in order to find a nearby access point with which to associate. That is, it will transmit request signals and then listen for responses from one or more access points. The station may thereafter associate with the access point which returns the strongest response signal (i.e. has the highest received signal strength indication, or signal-to-noise ratio or any other criterion). However, active scanning conflicts with the ideals of the present invention, whereby wireless resources are allocated to groups of stations.

In embodiments of the present invention, therefore, one or more advertising channels are defined on which all such networks can be discovered by compliant stations. That is, in one embodiment, the advertising channel(s) have the same frequency or frequencies over all standard-compliant networks. Alternatively, the advertising channel(s) may comprise one (or a repeated) time slot on a particular channel (which channel may include resources for transmitting other data or signals). In either embodiment, each access point transmits a broadcast signal over the one or more advertising channels, including one or more parameters associated with that access point such as its identity, the channels (frequency) on which it is operating, and the timing of its access intervals. In other embodiments, the broadcast signal may include the frequencies or codes which are allocated to the groups of stations. Stations may then listen for the broadcast signal and associate with the access point for which the received broadcast signal is strongest.

The station may be allocated to a group of stations in different ways according to different embodiments of the present invention. In one embodiment each station is associated with a unique identifier (e.g. a MAC address). By performing a hash function on the unique identifier, a lower value number (for example a single digit) is obtained which can be mapped to a group of stations. Each station may store a look-up table for the purpose of mapping the hash value to the allocated group of stations, or alternatively the access point may broadcast suitable mapping functions, for example in the broadcast signal transmitted over the advertising channel(s).

In an alternative embodiment, one portion of wireless resources (e.g. one access interval, one frequency or one code) is allocated to stations which are not associated with any access point. The allocated resources may be broadcast to stations using the broadcast signal transmitted over the advertising channel(s). Unassociated stations can then initiate association with the access point using these reserved resources.

In either case, once the station is associated with an access point, in one embodiment the initial allocation of the station to a particular group may be changed, at the request of the station itself or the access point. This allows stations to be allocated to groups according to one or more different criteria.

For example, stations can be grouped based on their service data rate so that quality of services can be ensured for those stations. That is, resources may be allocated more generously to some groups of stations than others (e.g. longer access intervals, a wider range of frequencies, or a greater number of codes). Stations with higher service data rates can be allocated to groups with greater allocations of resources. Alternatively, resources may be allocated evenly across the groups of stations, but each station may be allocated to a number of groups according to its service data rate. Stations with relatively high service data rates can be allocated to more groups than stations with relatively low service data rates. In a still further alternative embodiment, it may be preferable to balance the load caused by stations with high service data rates. In this case the stations with high service data rates may be distributed evenly amongst the groups of stations.

In other embodiments, stations can be allocated to groups according to their geographical location. Thus, stations which are near to each other in one geographical area can be allocated into one group, and stations which are near to each other in another geographical area can be allocated into another group. One method of achieving this is for each station to report to the access point a list of other stations whose communications it can detect. The access point is able to build a matrix of stations and their locations relative to each other, and thereafter to group stations according to their geographical location. In this way stations within a group can hear each other's communications, allowing for improved collision avoidance when competing to transmit or receive on the resources allocated to the group.

In one embodiment, in addition to their allocation to one or more groups, each station is allocated to a common “broadcast group”. A portion of wireless resources are reserved for this broadcast group (to which all stations are allocated) to enable efficient broadcast or multicast of communications.

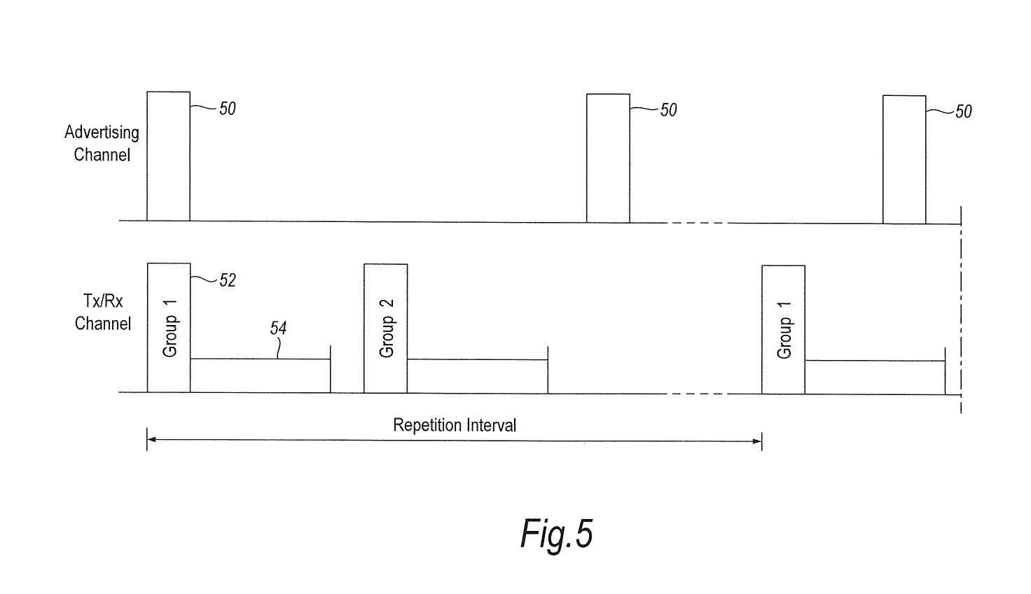

FIG. 5 shows a schematic signalling diagram for an access point according to embodiments of the present invention.

As described above, on one or more advertising channels, the access point transmits periodic beacon signals 50 to allow stations to discover and associate with the access point. The beacon signals 50 may include one or more of: the access point identity; the access point transmission frequency (or frequencies); the timing of the access intervals (or alternatively the frequencies and/or codes and their allocation to groups of stations); the allocation of hash codes to groups of stations.

On its regular transmit/receive channel, the access point transmits beacon frames 52, each beacon frame marking the start of an access interval 54 reserved for a particular group of stations. The beacon frame may therefore comprise one or more of: the group identity for which the access interval is reserved; the duration of the access interval; and the repetition interval for the access interval (i.e. the amount of time between access intervals reserved for the same group of stations). In an embodiment the access interval duration and/or the repetition interval are measured from the target beacon transmission time (TBTT) to avoid timing drift caused by the beacon transmission being delayed by other traffic. Note that in general the access intervals and the repetition intervals for each group of stations may not be the same.

Stations 14 can thus listen for beacon frames 52 transmitted by the access point 12 and determine if the ensuing access interval is reserved for the a group of stations to which that particular station is allocated. If not, the station can enter a low power mode for the duration of the access interval until it is required to listen for another beacon frame 52. For example, the RX/TX circuitry 34 may be powered down while the station 14 is neither transmitting nor listening for transmissions from the access point 12.

Although the access interval duration field in the beacon frame 52 marks the end of the access interval, in one embodiment the actual access interval duration may be elastic, effectively marked by the start of the next beacon frame 52. In this embodiment, stations are permitted to finish a transmission that was started before the nominal end of the access interval. If the medium is quiet, the access point 12 can send the next beacon frame 52 immediately after the end of the preceding access interval. If a station is still transmitting, the access point 12 may wait until the end of the transmission before transmitting the next beacon frame 52.

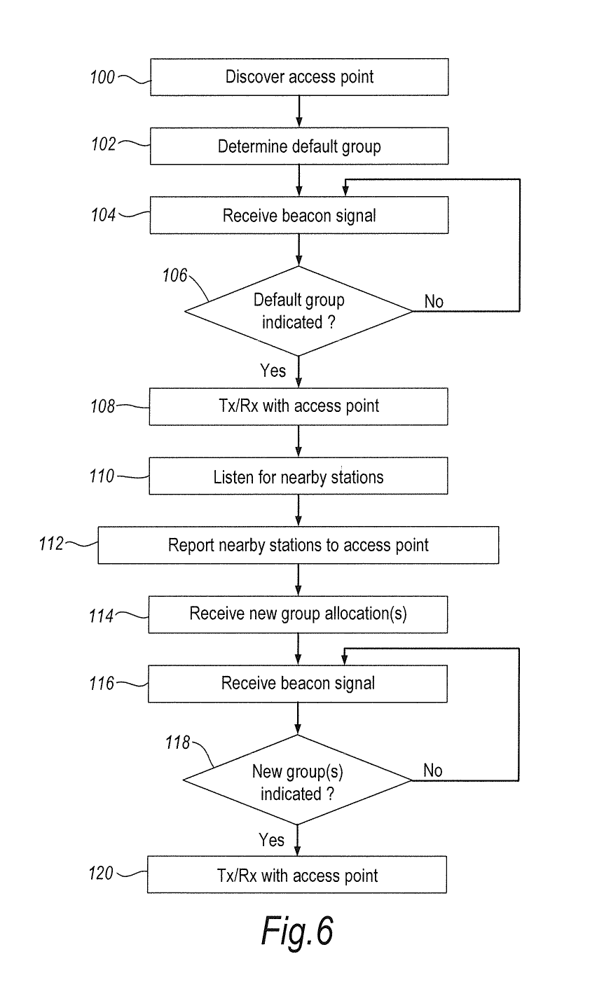

FIG. 6 is a flow chart of a method in a station according to embodiments of the present invention. The flow chart illustrates various aspects of communication between the station and an access point, including initial association of the station with the access point, reporting of nearby stations, and allocation to different groups of stations. Thus the not all of the steps in the illustrated method are essential to the present invention, and they need not be performed in the illustrated order.

The method begins in step 100, where the station 14 is first switched on (i.e. initially it is not associated with a particular access point), and where the station 14 discovers a nearby access point. As described above, the station 14 may scan for and discover access points in a variety of ways. In one embodiment, it may listen for broadcast signals on a dedicated advertising channel, selecting the access point associated with the strongest received broadcast signal. In other embodiments, it may scan passively or actively for nearby access points.

In step 102, the station determines its default group allocation. Again, a number of methods may be used to achieve this. In one embodiment, the station may hash a unique identifier associated it (such as the MAC address) and map this to a group of stations using a look-up table. In another embodiment, the station may be allocated to a default group reserved for stations which are initially unallocated. This information may be preprogrammed into the station or signalled to the station in the beacon signal transmitted over the advertising channel(s).

At a later point, in step 104, the station 14 receives a beacon frame sent over the Rx/Tx channel of the access point. The beacon frame identifies a group of stations, and may also include the access interval duration and/or the repetition interval of the access interval.

In step 106, the station determines whether the received beacon frame indicates the group to which it is allocated (i.e. the default group). If not, the method moves back to step 104 and waits for a further beacon frame to be transmitted. Optionally, the station may enter a low-power state for the access interval duration specified in the beacon frame in order to save power. If the beacon frame does indicate the default group, the method proceeds to step 108 where the station can transmit communications to the access point or receive communications from the access point during the access interval specified in the beacon frame. Clearly, it is possible that neither the access point nor the station will need to communicate during the access interval. However, a number of possible communications are illustrated for completeness.

In step 110, the station 14 listens for communications from other nearby stations, and stores the identity of any station which is recognized. Those skilled in the art will appreciate that this process may take place at any time, and is not limited to the location specified in FIG. 6. Nonetheless, in step 112, the station 14 uses the access interval to transmit a list of nearby identified stations to the access point. As discussed above, this may trigger an allocation to a new group of stations such that the station is allocated to a group with other stations in its vicinity. In step 114, then, a signal is received from the access point which allocates the station to one or more new groups. In this example, the station is further de-allocated from its default group, but in other embodiments the default allocation may be kept in addition to the new allocations.

In step 116, a further beacon frame is received from the access point, again identifying a group of stations for which the ensuing access interval is reserved. If the identified group of stations does not match one of the new groups allocated to the station in step 114 (step 118), the process move back to step 116 and waits for a further beacon frame to be transmitted. Optionally, the station may enter a low-power state for the access interval duration specified in the beacon frame in order to save power. If the received beacon frame does specify one of the groups to which the station is newly allocated, the station is permitted to receive transmissions from or transmit to the access point in step 120.

The present invention thus describes access points and stations for use in a wireless local area network, and methods in those devices. According to embodiments of the present invention, each station is allocated into one or more groups of stations. Wireless resources for communication between the stations and one or more access points (e.g. time, frequency and/or codes) are partitioned into portions and each group allocated a particular portion of those resources. The stations of a particular group are then permitted to compete for access using the portion of resources allocated to that group. Stations which are not allocated to that group are not permitted to compete for those resources.

1. A method in a station of a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point, the method comprising:
identifying a group of stations to which the station is allocated; and
transmitting one or more communications to the access point, or listening for communications intended for the station from the access point, using the portion of wireless resources reserved for said identified group of stations.

2. The method according to claim 1, wherein said step of transmitting data comprises:
listening for other communications using said reserved portion of wireless resources from other stations in said identified group of stations; and
in the absence of said other communications, transmitting data to the access point using said reserved portion of wireless resources.

3. The method according to claim 1, wherein said step of identifying a group of stations comprises:
deriving said group of stations from a unique identifier associated with the station.

4. The method according to claim 3 wherein said step of deriving comprises hashing said unique identifier.

5. The method according to claim 3 wherein said unique identifier comprises the MAC address of said station.

6. The method according to claim 1, wherein said step of identifying a group of stations comprises:
receiving a communication from the access point allocating the station to a group of stations.

7. The method according to claim 1, wherein each station is allocated to one or more of the plurality of groups of stations according to each station's respective physical location.

8. The method according to claim 7, further comprising:
listening for communications from other stations; and
transmitting to the access point a list of said other stations.

9. The method according to claim 1, wherein each station is allocated to one or more of the plurality of groups of stations according to their respective service data rate.

10. The method according to claim 1, wherein the wireless resources comprise one or more of time, transmission frequencies, and codes used to encode transmissions.

11. The method according to claim 10, wherein the reserved portion of wireless resources comprises a time interval.

12. The method according to claim 11, further comprising:
receiving a beacon signal from the access point, identifying said time interval.

13. The method according to claim 12, wherein said beacon signal further identifies the group of stations for which said time interval is reserved.

14. The method according to claim 13, wherein said beacon signal further identifies a duration of said time interval and/or a repetition rate of said time interval.

15. The method according to claim 14, wherein the duration of said time interval and/or the repetition rate varies as between groups of stations.

16. The method according to claim 11, wherein said step of transmitting one or more communications to the access point comprises:
starting to transmit a communication during said time interval; and
finishing the transmission of said communication after said time interval has ended.

17. A station for a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point, the station comprising:
a transceiver for transmitting communications to the access point and receiving communications from the access point; and
a controller for controlling the transceiver, the controller configured to:
identify a group of stations to which the station is allocated; and
control the transceiver to transmit one or more communications to the access point, or to listen for communications intended for the station from the access point, using the portion of wireless resources reserved for said identified group of stations.

18. A controller for a station of a wireless local area network, the network comprising an access point with which a plurality of stations can communicate using wireless resources, wherein each station is allocated to one or more of a plurality of groups of stations, and wherein each group of stations is allocated a portion of the wireless resources for communicating with the access point, the station further comprising a transceiver for transmitting communications to the access point and receiving communications from the access point, the controller configured to:
identify a group of stations to which the station is allocated; and
control the transceiver to transmit one or more communications to the access point, or to listen for communications intended for the station from the access point, using the portion of wireless resources reserved for said identified group of stations.

19. A method in an access point of a wireless local area network, the network comprising a plurality of stations which can communicate with the access point using wireless resources, wherein each station is allocated to one or more of a plurality of groups of stations, the method comprising:
transmitting a beacon signal to the plurality of stations, the beacon signal identifying a portion of the wireless resources and the group of stations for which the identified portion of wireless resources is reserved for communications with the access point.

20. The method according to claim 19, wherein the wireless resources comprise one or more of time, transmission frequencies, and codes used to encode transmissions.

21. The method according to claim 20, wherein the beacon signal identifies a time interval in which the group of stations are permitted to communicate with the access point.

22. The method according to claim 21, further comprising:
transmitting a further beacon signal, identifying a further time interval and identifying a further group of stations permitted to communicate with the access point in said further time interval.

23. The method according to claim 22, further comprising:
listening for communications extending beyond the end of said time interval; and
only transmitting said further beacon signal once said communications have finished.

24. The method according to claim 19, further comprising:
transmitting a broadcast signal on wireless resources to which all stations have access, the broadcast signal identifying the access point and the timing of said beacon signal.

25. The method according to claim 19, further comprising:
transmitting a control signal to a station of the plurality of stations, the control signal allocating the station to one or more of the groups of stations.

26. The method according to claim 25, wherein the station is allocated to one or more of the groups of stations according to a physical location of the station or a service data rate of the station.

27. An access point for a wireless local area network, the network comprising a plurality of stations which can communicate with the access point using wireless resources, wherein each station is allocated to one or more of a plurality of groups of stations, the access point comprising:
a transceiver for transmitting communications to the plurality of stations and receiving communications from the plurality of stations; and
a controller for controlling the transceiver, the controller configured to:
control the transceiver to transmit a beacon signal to the plurality of stations, the beacon signal identifying a portion of the wireless resources and the group of stations for which the identified portion of wireless resources is reserved for communications with the access point.

28. A controller for an access point for a wireless local area network, the network comprising a plurality of stations which can communicate with the access point using wireless resources, wherein each station is allocated to one or more of a plurality of groups of stations, the access point further comprising a transceiver for transmitting communications to the plurality of stations and receiving communications from the plurality of stations, the controller being configured to:
control the transceiver to transmit a beacon signal to the plurality of stations, the beacon signal identifying a portion of the wireless resources and the group of stations for which the identified portion of wireless resources is reserved for communications with the access point.
